(19) United States
(12) Patent Application Publication
(10) Pub. No.: US 2015/0293509 A1
(43) Pub. Date: Oct. 15, 2015

(54) IN-VEHICLE HOME AUTOMATION INTEGRATION

(71) Applicant: Ford Global Technologies, LLC, Dearborn, MI (US)

(72) Inventors: Stefan BANKOWSKI, Royal Oak, MI (US); Markos RAPITIS, Livonia, MI (US); Aaron DeGROW, Berkley, MI (US); Kevin BURDETTE, Plymouth, MI (US); Elizabeth HALASH, Dearborn, MI (US); Edward WEHRMAN, Leesburg, VA (US)

(73) Assignee: Ford Global Technologies, LLC, Dearborn, MI (US)

(21) Appl. No.: 14/253,367

(22) Filed: Apr. 15, 2014

(51) Int. Cl. G05B 15/02; H04L 12/28

(52) U.S. Cl. CPC G05B 15/02; H04L 12/2818

(57) ABSTRACT

A nomadic device may be configured to connect to a vehicle computing system over a local connection and to an automation service over a wide-area connection, receive a message from the vehicle computing system over the local connection requesting a home automation action to be performed, and responsive to the message, send a command over the wide-area connection to an automation service to request the home automation action. A vehicle controller may be configured to connect to a nomadic device over a local connection, the nomadic device configured to connect to an automation service over a wide-area connection, receive input to a user interface of the vehicle computing system requesting performance of a home automation action of the automation service, and responsive to the input, send a command over the local connection to request the home automation action.

### TECHNICAL FIELD

The illustrative embodiments generally relate to the integration of home automation features into a vehicle telematics system.

### BACKGROUND

A home automation system may be configured to provide for centralized control of various home systems, such as lighting, climate and security. The popularity of such home automation systems continues to increase, in part due to the increased availability of Internet-connected smartphone devices that may serve to remotely command the home automation control functions. However, such systems may be cumbersome or dangerous to use in the vehicle environment.

### SUMMARY

In a first illustrative embodiment, a system includes a nomadic device configured to connect to a vehicle computing system over a local connection and to an automation service over a wide-area connection, receive a message from the vehicle computing system over the local connection requesting a home automation action to be performed, and responsive to the message, send a command over the wide-area connection to an automation service to request the home automation action.

In a second illustrative embodiment, a system includes a vehicle controller configured to connect to a nomadic device over a local connection, the nomadic device configured to connect to an automation service over a wide-area connection, receive input to a user interface of the vehicle computing system requesting performance of a home automation action of the automation service, and responsive to the input, send a command over the local connection to request the home automation action.

In a third illustrative embodiment, a system includes a nomadic device configured to identify an automation status in a home under automation control of an automation service, identify a current vehicle location, and when the vehicle is determined to be at least a predetermined distance from the home, send a message to the vehicle configured to cause the vehicle to display an automation alert in a user interface of the vehicle, the alert specifying the automation status.

### BRIEF DESCRIPTION OF THE DRAWINGS

FIG. 1 is an exemplary block topology of a vehicle infotainment system implementing a user-interactive vehicle based computing system;

FIG. 2 illustrates an exemplary in-vehicle home automation system;

FIG. 3 illustrates an exemplary login screen user interface of the automation control application configured to receive credentials to an automation service;

FIG. 4 illustrates an exemplary user interface of the vehicle infotainment system from which connected applications are selected;

FIG. 5 illustrates an exemplary main user interface of the automation control application;

FIGS. 6A and 6B illustrates an exemplary temperature control user interface of the automation control application; and

FIG. 7 illustrates an exemplary door control user interface of the automation control application;

FIG. 8 illustrates an exemplary lights control user interface of the automation control application;

FIG. 9 illustrates an exemplary vehicle user interface presenting an automation alert generated by the automation application;

FIG. 10 illustrates an exemplary process for requesting automation services via the vehicle HMI;

FIG. 11 illustrates an exemplary process for performing automation services via the nomadic device; and

FIG. 12 illustrates an exemplary process for providing automation alert services.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A home automation application on a user's mobile device may be configured to integrate with a telematics system of a vehicle, to allow a driver or other user of the vehicle to access home automation features from within the vehicle human-machine interface (HMI). The application may be further configured to connect to various third-party home automation services associated with the mobile device, to allow the system to send automation commands as well as to receive status information regarding the automated systems. Exemplary home services to be controlled via the vehicle may include, as some non-limiting examples, the Nest smart thermostat application programmer interface (API) maintained by Google, Inc. of Mountain View, Calif., and the Schlage Z-Wave Deadbolt cloud connected API maintained by Allegion Plc of Carmel, Ind. By integrating with the vehicle HMI, the home automation application may facilitate safe control of automation features via touch screen and voice command HMI interfaces of the vehicle.

In addition to allowing the user to command home automation features, the home automation application may be further configured provide in-vehicle updates or alerts if certain home automation components change status. In an example, the home automation application may be configured to display an alert if home doors are unexpectedly opened while user is not home (e.g., as determined by the vehicle location). Based on detection of the unexpected condition, the home automation application may be configured to issue an in-vehicle alert to the user via the display HMI and/or by way of an audio prompt.

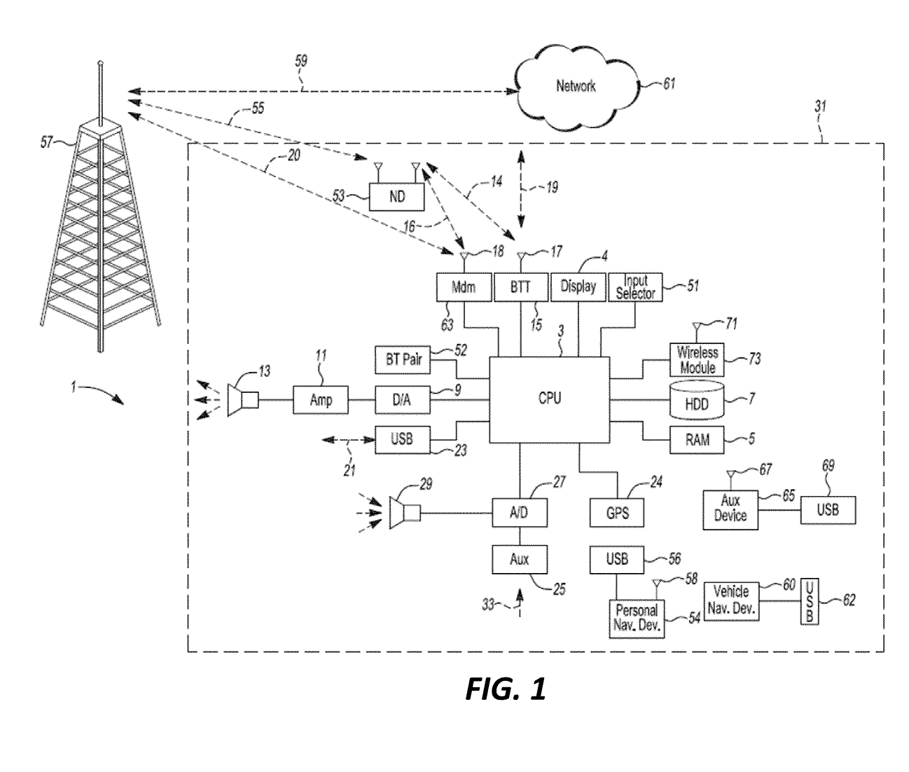

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

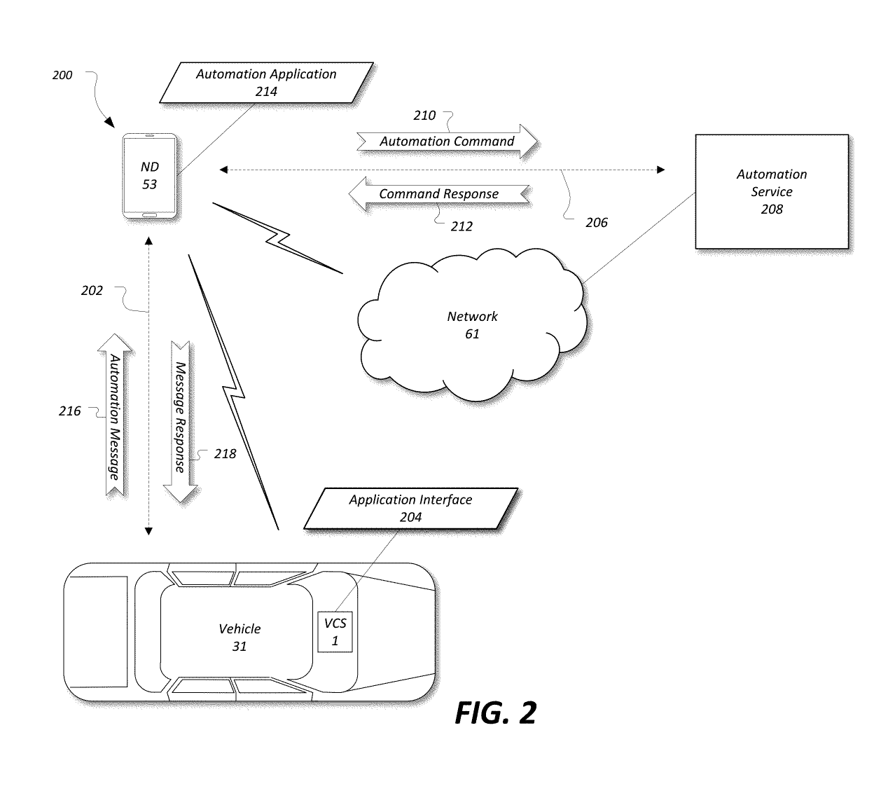

FIG. 2 illustrates an exemplary in-vehicle 31 home automation system 200. As illustrated, the system 200 includes a nomadic device 53 hosting a home automation control application 214 and in communication with an automation service 208 via a data connection 206 over the network 61. The system further includes a connected application interface 204 of the VCS 1 configured to allow the VCS 1 to integrate with and control connected applications (such as the home automation control application 214) via a local data connection 202. It should be noted that the illustrated system 200 is merely exemplary, and more, fewer, and/or differently located elements may be used. As one example, the system 200 may include multiple remote automation services 208. As another example, the home automation control application 214 may be executed in whole or in part by the VCS 1 or other vehicle processor.

To facilitate the integration of connected applications hosted by the nomadic device 53 with the HMI of the VCS 1, the system 200 may set up the local data connection 202 between the nomadic device 53 and the VCS 1. As an example, for a nomadic device 53 running the Android operating system maintained by the Open Handset Alliance of Silicon Valley, Calif., the data connection 202 may be established via a wireless Bluetooth connection. As another example, for a nomadic device 53 running the iOS operating system maintained by Apple, Inc. of Cupertino, Calif., the data connection 202 may additionally or alternately be established over a wired USB connection (not shown).

Once connected via the connection 202, the application interface 204 may provide communication services between the VCS 1 and the nomadic device 53. As one example, the connection application interface 204 may support the querying by the VCS 1 for a list of the connected applications available on the nomadic device 53 and compatible with VCS 1 control. As another example, the connection application interface 204 may facilitate arbitration of communication resources of the connection 202 between the VCS 1 and the nomadic device 53, to allow the connected applications of the nomadic device 53 to send and receive data from the VCS 1.

As yet a further example, the connection application interface 204 may support the addition of HMI screens and voice commands to the HMI of the VCS 1 by the connected applications executed by the paired nomadic device 53. A non-limiting example of an implementation of a connection application interface 204 may be the SYNC APPLINK API provided by THE FORD MOTOR COMPANY. The nomadic device 53 may further be configured to establish a wide-area data connection 206 (e.g., an Internet connection) between the nomadic device 53 and an automation service 208, such as a connection over the network 61.

The automation service 208 may be configured to receive home automation commands 210 from connected devices (e.g., the nomadic device 53), and provide the home automation commands to be executed to the controlled customer premises (e.g., customer homes). The automation service 208 may be further configured to provide command responses 212 to the senders of the home automation commands 210 to inform the command requester of the status of the home automation commands 210. Exemplary remote automation services 208 may include, as some non-limiting examples, the Nest smart thermostat application programmer interface (API) maintained by Google, Inc. of Mountain View, Calif., and the Schlage Z-Wave Deadbolt cloud connected API maintained by Allegion Plc of Carmel, Ind.

The automation service 208 may be configured to require security credentials to allow a device such as the nomadic device 53 to access the automation features of the automation service 208. As some examples, the automation service 208 may require an account name or username, and a password, passphrase, personal identification number, fingerprint, or other credential that may be used by the automation service 208 to ensure that the requesting device is authorized to access the automation service 208 features for the corresponding account or user.

The automation control application 214 may be configured to provide home automation features to the VCS 1 via the connection application interface 204 to the VCS 1. For example, the automation control application 214 may be configured to integrate with the HMI of the VCS 1 by way of the connection application interface 204. The integration of the automation control application 214 into the vehicle HMI may include the addition of home automation user interface screens to the vehicle HMI, as well as the addition of home automation of voice commands to the vehicle HMI. As an example, the automation control application 214 may be configured to add vehicle HMI commands facilitating control of a thermostat automation service 208, to allow the user to view and set home temperature and thermostat settings. As another example, the automation control application 214 may be configured to add vehicle HMI commands facilitating control of a security automation service 208, to allow the user to view current door lock status, and lock or unlock service-controlled doors and locks.

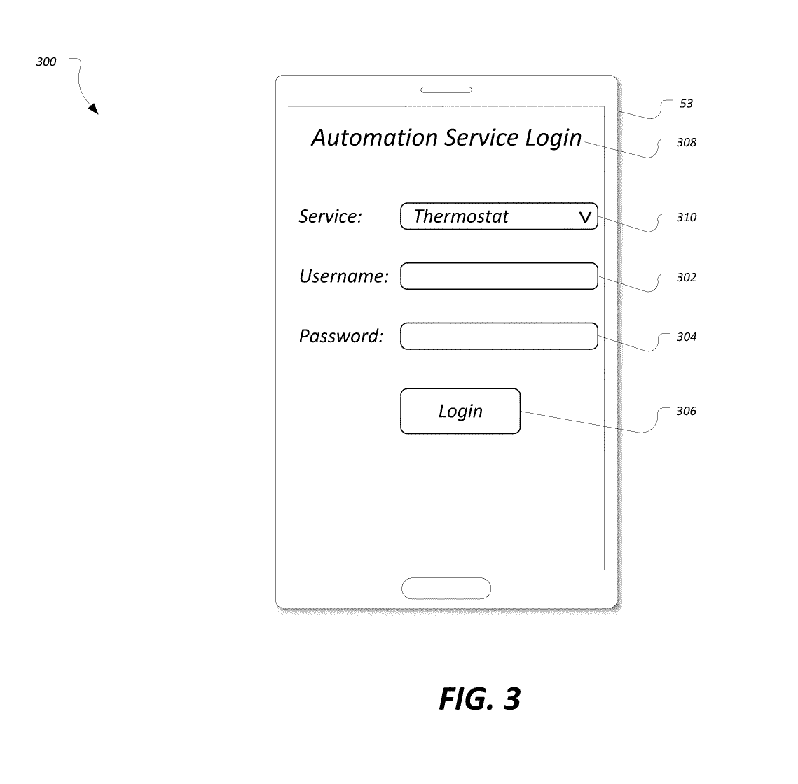

To perform the controlling, automation control application 214 may be configured to receive automation messages 216 from the vehicle HMI of the VCS 1, provide automation commands 210 to the automation service 208 based on the received automation messages 216, receive command responses 212 from the automation service 208, and provide message responses 218 to the VCS 1 based on the received command responses 212. Further details of the integration of the automation control application 214 are discussed in detail below with respect to FIGS. 3-10 below.

FIG. 3 illustrates an exemplary login screen user interface 300 of the automation control application 214 configured to receive credentials to an automation service 208. The automation control application 214 may be configured to provide the login user interface 300 to the user via the nomadic device 53. (In other examples, the login user interface 300 may be provided by the VCS 1, e.g., via display 4.) In an example, the user interface 300 may include a username field 302 and a password field 304 into which a user may enter the required credentials (or provide the credentials via voice commands). The user interface 300 may further include a login control 306 that the user may select to provide and save the entered login information. The user interface 300 may also include a title label 308 to indicate to the user that the user interface 300 is for entering automation service 208 login credentials.

In some cases, the user interface 300 may further include a services dropdown control 310, from which the user may select from possible automation services 208 supported by the automation control application 214. As illustrated, the services dropdown control 310 indicates that the user interface 300 is receiving credential information for a thermostat automation service 208 (such as the Nest thermostat service). As some other examples, the services dropdown control 310 may include entries for security services (such as the Schlage security service), and lighting and/or appliance control services. In some cases, as login information may vary according to automation service 208, the specific controls receiving credential information (e.g., the username field 302 and a password field 304 as illustrated) may be adjusted to conform to the credential requirements of the specified automation service 208.

The received login information may be used by the automation control application 214 to cause the nomadic device 53 to log into the automation service 208 via the data connection 206. Once logged in, the automation control application 214 may be configured to command the automation service 208 to perform automation functions in accordance with user requests (e.g., automation messages 216) provided by the user via the VCS 1. The login information may also be stored by the nomadic device 53 in a memory of the nomadic device 53 to allow the nomadic device 53 automatically log into the automation service 208, without requiring the capture of credential login information each time the automation control application 214 is initiated.

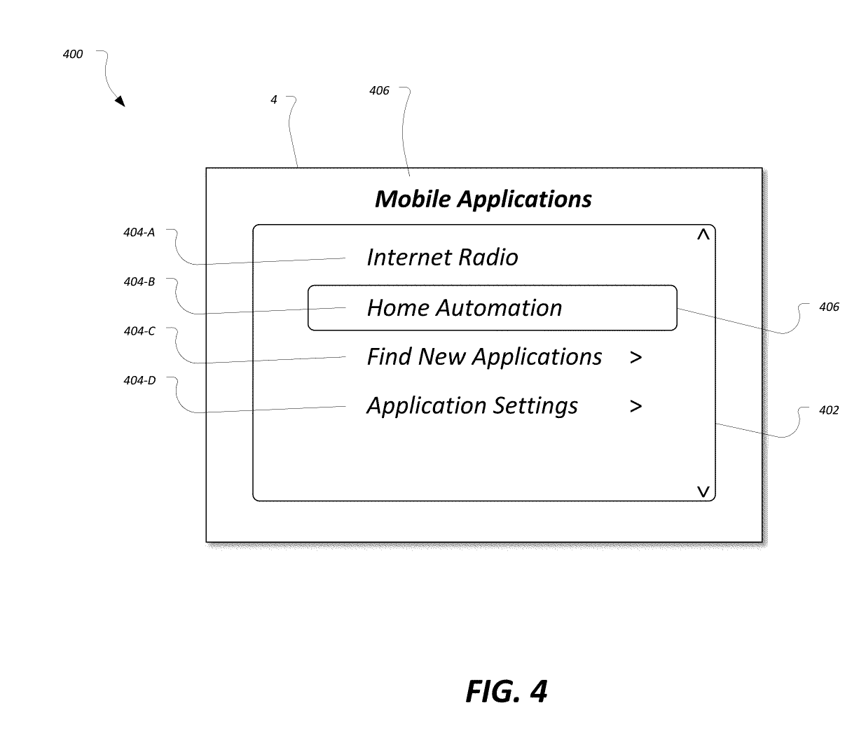

FIG. 4 illustrates an exemplary user interface 400 of the VCS 1 from which connected applications are selected. As mentioned above, the connection application interface 204 may support the VCS 1 querying for a list of the connected applications available on the nomadic device 53. The user interface 400 may include a list control 402 configured to display the queried connected applications as selectable list entries 404. The user interface 400 may also include a title label 408 to indicate to the user that the user interface 400 is for utilizing the connected applications of the nomadic device 53.

As illustrated, the list control 402 of the connected application includes an entry 404-A for an Internet radio application and an entry 404-B for the automation control application 214. The list control 402 may operate as a menu, such that a user of the user interface 400 may be able to scroll through list entries of the list control 402 (e.g., using up and down arrow buttons and a select button to invoke the selected menu item 406). In some cases, the list control 402 may be displayed on a touch screen display 4, such that the user may be able to touch the list control 402 to select and invoke a menu item. For example, when the entry for the automation control application 214 is selected, the VCS 1 may send a command via the connected application interface 204 to the nomadic device 53, to cause the nomadic device 53 to initiate the automation control application 214. As another example, the vehicle HMI may support voice command selection of the menu items. For example, to invoke the automation control application 214, the user may press a push-to-talk button within the vehicle 31, and may speak the voice command “home automation.”

The list control 402 may further include additional entries. For example, the “Find new Apps” entry 404-C, when invoked, may be configured to cause the VCS 1 to query the nomadic device 53 via the connected application interface 204 for an updated listing of the connected applications installed on the nomadic device 53. As another example, the “App settings” entry 404-D, when invoked, may be configured to cause the VCS 1 to display a user interface of settings for the connected applications functionality.

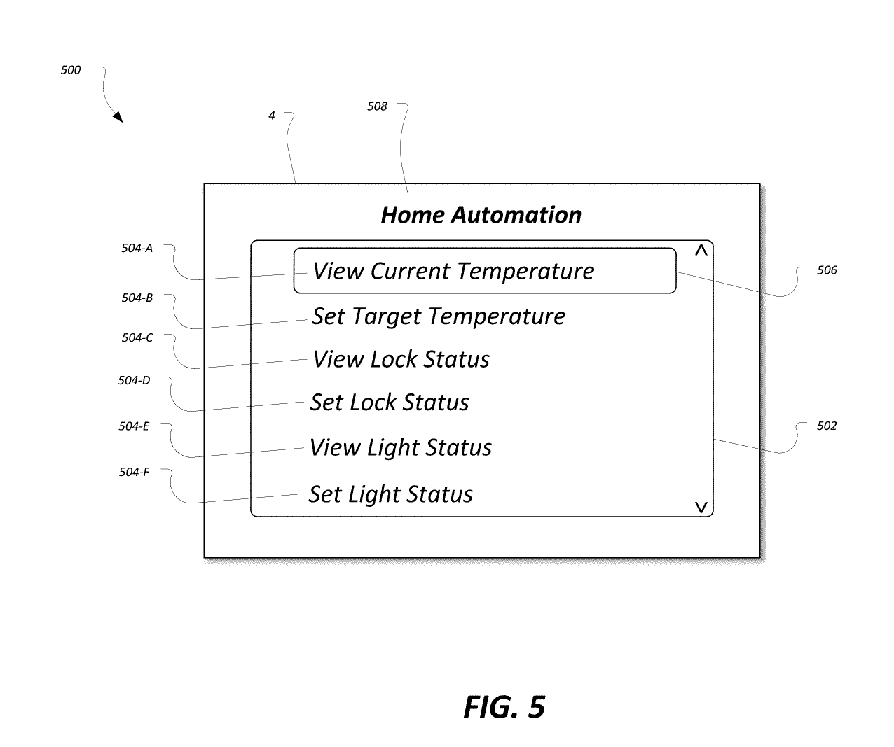

FIG. 5 illustrates an exemplary main user interface 500 of the automation control application 214. As with the user interface 400, the user interface 500 may be presented in the vehicle 31 via the display 4. The user interface 500 may include a list control 502 configured to display a selectable list of entries, where each entry is associated with a corresponding application command 504-A through 504-C (collectively 504). Each of the commands 504 may indicate a feature available for use by the VCS 1 in communication with the automation control application 214. The user interface 400 may also include a title label 508 to indicate to the user that the user interface 500 is for the automation control application 214 (e.g., as invoked via the entry 404-B of the user interface 400).

With respect to the commands 504 of the list control 502, as one example, the list control 502 may include a command 504-A that, when invoked, is configured to cause the VCS 1 to display a user interface including current temperature information. As another example, the list control 502 may include a command 504-B that, when invoked, is configured to cause the VCS 1 to display a user interface for setting a target temperature. The list control 502 may include further commands as well, such as a command 504-C for providing current lock status, a command 504-C for setting lock status, a command 504-E for providing current light status, and a command 504-F for setting current light status 504-F.

As with the list control 402, the list control 502 may also operate as a menu, such that a user of the user interface 500 may be able to scroll through list entries of the list control 502 (e.g., using up and down arrow buttons and a select button to invoke the selected menu item 506). Upon touch or button selection of one of the commands 504, the VCS 1 may be configured to perform the select action.

Notably, each of the commands 504 of the list control 502 may also be associated with a vehicle HMI voice command. As some examples, to invoke the command 504-A, the user may press a push-to-talk button within the vehicle 31, and may speak the voice command “view current temperature,” while to invoke the command 504-B, the user may instead speak the voice command “set target temperature.” Thus, each of the commands 504 of the user interface 500 may also function as a voice command to invoke the specified functionality of the automation control application 214.

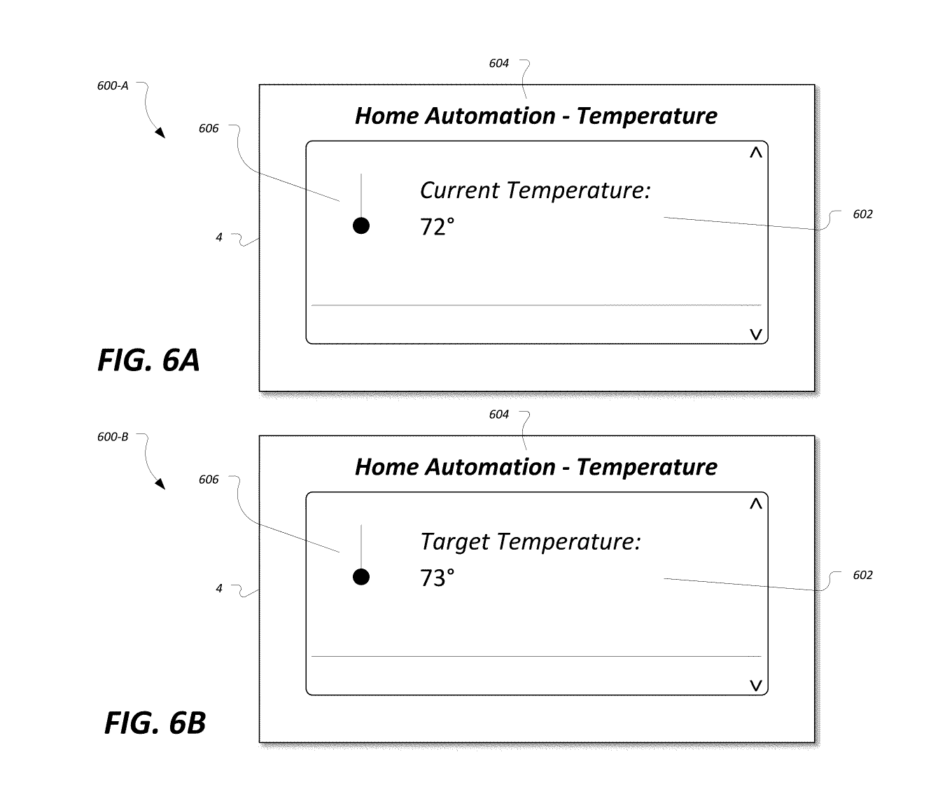

FIG. 6A illustrates an exemplary current temperature user interface 600-A of the automation control application 214. As with the user interfaces 400 and 500, the user interface 600-A may also be presented in the vehicle 31 via the display 4. The user interface 600 may be invoked, for example, via selection of the view current temperature command 504-A from the user interface 500. As illustrated, the user interface 600-A may include temperature information 602 indicating the current temperature of the home (e.g., 72° as illustrated). The user interface 600-A may also include a title label 604 to indicate to the user that the user interface 600-A is for the current temperature information screen of the automation control application 214. The user interface 600-A may also include an icon 606 (e.g., a thermometer) or other graphic indicating to the user that temperature information 602 is being presented.

The VCS 1 may be configured to provide automation messages 216 requesting information to the automation control application 214 via the connected application interface 204. For example, the VCS 1 may provide an automation message 216 to the automation control application 214 requesting current temperature information to provide in the temperature information 602 of the user interface 600-A. Responsive to the automation message 216, the automation control application 214 may send an automation command 210 to the temperature automation service 208 requesting the current temperature information. The automation service 208 receiving the request may, for example, request the information from the home thermostat linked to the logged-in user account making the request, and return the requested information to the automation control application 214 in a command response 212. The requested information may then be provided to the VCS 1 in a message response 218.

FIG. 6B illustrates an exemplary current temperature user interface 600-B of the automation control application 214. As with the user interfaces 400, 500 and 600-A, the user interface 600-B may also be presented in the vehicle 31 via the display 4. The user interface 600-B may be invoked, for example, via selection of the set target temperature command 504-B from the user interface 500. As illustrated, the user interface 600-B may include temperature information 602 indicating the target temperature of the home (e.g., 73° as illustrated). The user interface 600-B may also include a title label 604 to indicate to the user that the user interface 600-B is for the set target temperature information screen of the automation control application 214, as well as an icon 606 (e.g., a thermometer) or other graphic indicative the user that temperature information 602 is being presented.

When the user requests to set the target temperature (e.g., via providing a “set target temperature” voice command to the VCS 1), the VCS 1 may be configured to provide an automation message 216 to the automation control application 214, via the connected application interface 204 connected to the nomadic device 53 by way of the local connection 202. For example, if the user wishes to increase the target temperature for the first zone 602-A from 72° to 73°, the user may speak “set target temperature seventy-three degrees.” Responsive to the voice command, the VCS 1 may be provide an automation message 216 to the automation control application 214 via the connected application interface 204 requesting, in the example, to set the target temperature to 73°. In turn, the automation control application 214 may send an automation command 210 over the data connection 206 to the temperature automation service 208 to which the automation control application 214 is logged into (e.g., using log in information previously received via the user interface 300). The automation service 208 receiving the automation command 210 may, in turn, send a request to the home thermostat to adjust the target temperature. The automation service 208 may further return a result to the automation control application 214 in a command response 212 indicative of whether the setting of the target temperature was successful, to be provided to the VCS 1 in a message response 218. Accordingly, by way of the temperature control user interface 600-B, a user may be able to adjust temperature settings of the home using the in-vehicle HMI.

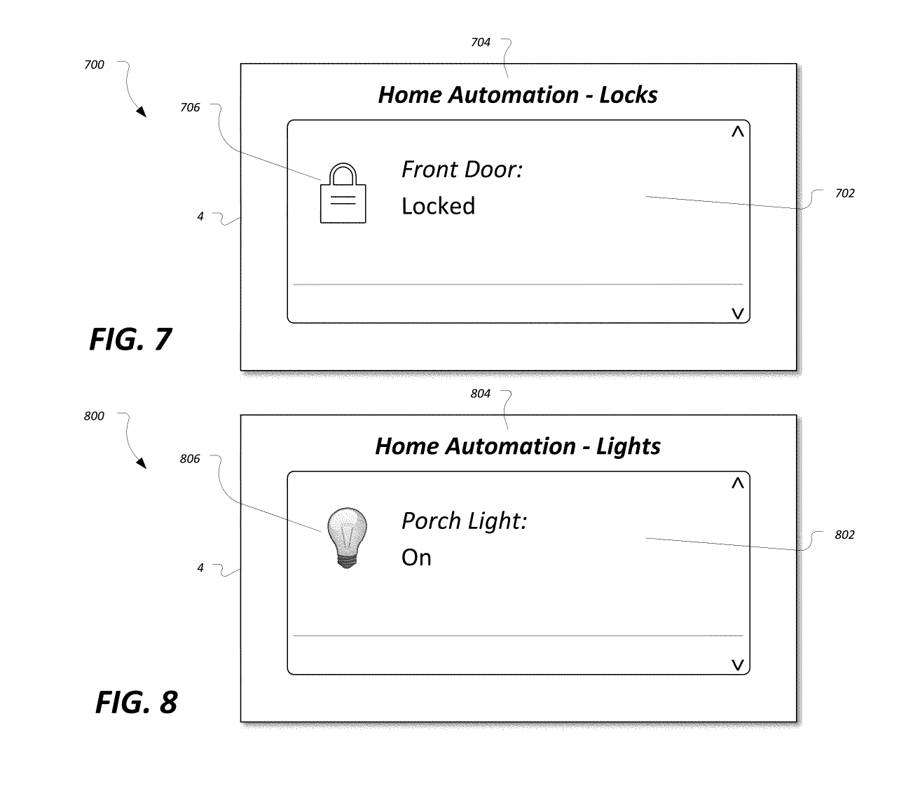

FIG. 7 illustrates an exemplary current lock status user interface 700 of the automation control application 214. As with the user interfaces 400-600, the user interface 700 may also be presented in the vehicle 31 via the display 4. The user interface 700 may be invoked, for example, via selection of the view lock status command 504-C from the user interface 500. As illustrated, the user interface 700 may include lock status information 702 indicating the current status of a door lock (e.g., the front door is locked). The user interface 700 may also include a title label 704 to indicate to the user that the user interface 700 is for the current lock status information screen of the automation control application 214, as well as an icon 706 (e.g., a lock) or other graphic indicating that lock status information 702 is being presented.

FIG. 8 illustrates an exemplary current light status user interface 800 of the automation control application 214. As with the user interfaces 400-700, the user interface 800 may also be presented in the vehicle 31 via the display 4. The user interface 800 may be invoked, for example, via selection of the view light status command 504-E from the user interface 500. As illustrated, the user interface 800 may include light status information 802 indicating the current status of a light (e.g., the porch light is on as illustrated). The user interface 800 may also include a title label 804 to indicate to the user that the user interface 800 is for the current light status information screen of the automation control application 214, as well as an icon 806 (e.g., a light bulb) or other graphic indicating that light status information 802 is being presented.

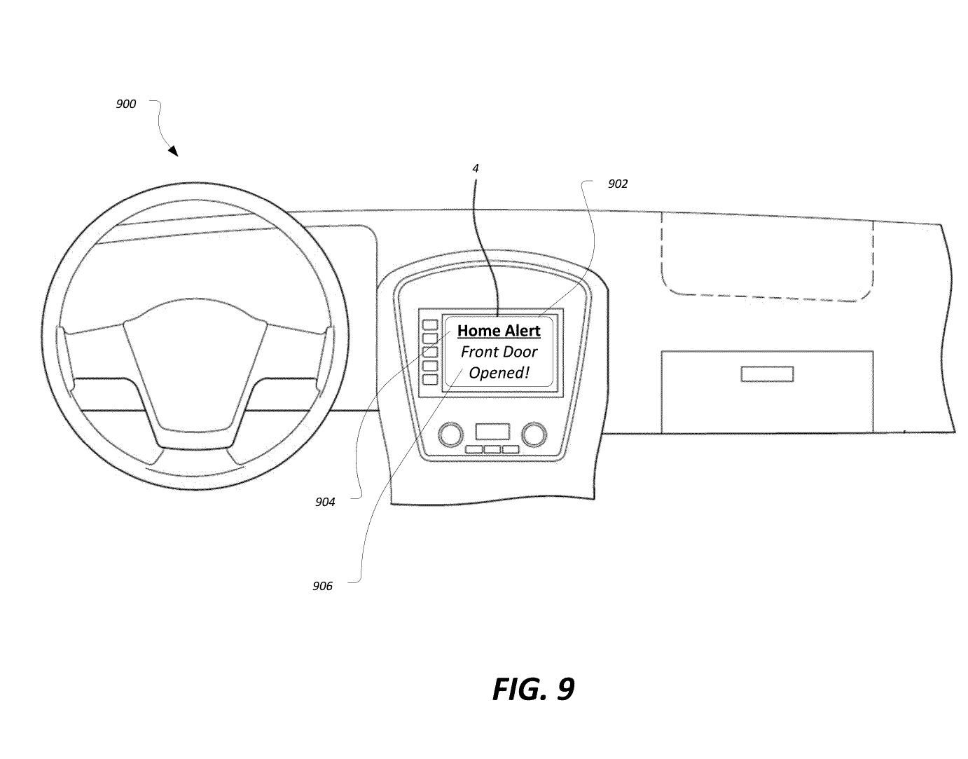

FIG. 9 illustrates an exemplary vehicle user interface 900 presenting an automation alert 902 generated by the automation application 214. The automation control application 214 may be configured to generate the automation alert 902 based on the automation control application 214 identifying that an automation state has changed (e.g., a light has been turned on, a door has been opened, etc.) when the vehicle 31 is not home (e.g., as determined according to GPS or other positioning information available to the automation control application 214). The automation alert 902 may include, for example, an indication 904 that the automation alert 902 is a home alert. The automation alert 902 may further include an alert description 906 of the alert condition. As illustrated, the alert description 906 indicates that the front door of the home was opened, although other alerts are possible.

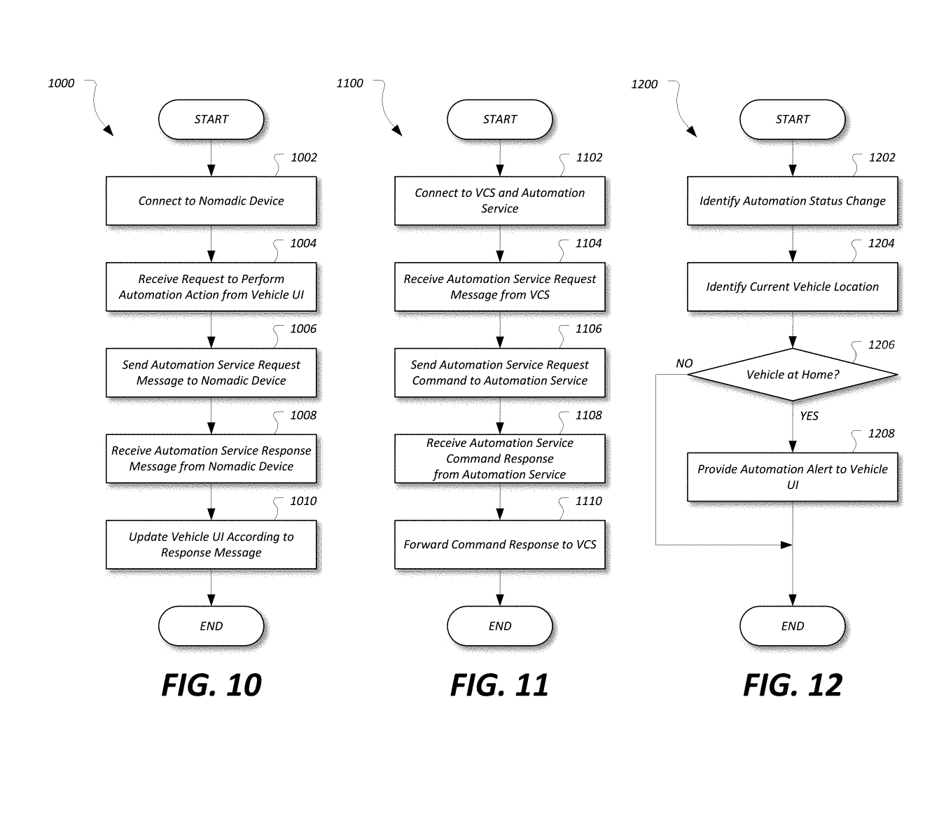

FIG. 10 illustrates an exemplary process 1000 for requesting automation services via the vehicle HMI. The process 1000 may be performed, for example, by the VCS 1 of the vehicle 31 integrated with the automation control application 214 executed by the nomadic device 53.

At block 1002, the VCS 1 connects to the nomadic device 53 over the local connection 202. For example, the connected application interface 204 of the VCS 1 may be configured to cause the VCS 1 to set up a local data connection 202 between the nomadic device 53 and the VCS 1. As one possibility, the data connection 202 may be established via a wireless Bluetooth connection. Additionally or alternate, the data connection 202 may be established over a wired USB connection.

At block 1004, the VCS 1 receives input to a user interface of the VCS 1 requesting performance of a home automation action of the automation service 208. For example, the VCS 1 may receive input as discussed above with respect to the user interfaces 500-800. Exemplary home automation actions may include, for example, commands getting or setting temperature settings of a home, commands locking, unlocking, opening, and closing doors of the home, and command turning on or off lights of the home.

At block 1006, the VCS 1 sends an automation request message 216 over the local connection 202 to the nomadic device 53 to request the home automation action. Accordingly, the VCS 1 may be provide the automation request message 216 to the automation control application 214, via the local connection 202 and connected application interface 204, requesting that the chosen action be performed (e.g., open a door, turn off a light, etc.).

At block 1008, the VCS 1 receives a message response 218 to the automation message 216 over the local connection 202. For example, responsive to the automation message 216 sent over the local connection 202, the automation control application 214 may provide a message response 218, via the local connection 202 and connected application interface 204, indicating whether the automation service 208 successfully performed the chosen action.

At block 1010, the VCS 1 updates the vehicle HMI according to the received message response 218. For example, if the message response 218 indicates the chosen action was successfully performed, the VCS 1 may be configured to update the user interface to indicate the updated state. If unsuccessful, the VCS 1 may not update the user interface, but may optionally provide an error message to the user. After block 1010, the process 1000 ends.

FIG. 11 illustrates an exemplary process 1100 for performing automation services via the nomadic device 53. The process 1100 may be performed, for example, by the automation control application 214 executed by the nomadic device 53, where the nomadic device 53 is in communication with the VCS 1 over the local connection 202 and with the automation service 208 via the wide-area connection 206.

At block 1102, the nomadic device 53 connects to the VCS 1 and to the automation service 208. For example, the automation control application 214 of the nomadic device 53 may be configured to cause the nomadic device 53 to set up a local data connection 202 between the nomadic device 53 and the VCS 1. As one possibility, the data connection 202 may be established via a wireless Bluetooth connection. Additionally or alternate, the data connection 202 may be established over a wired USB connection. Moreover, the automation control application 214 may set up a data connection 206 to the automation service 208, e.g., using log in information requested from the user via the user interface 300, or previously received via the user interface 300 and maintained by the nomadic device 53.

At block 1104, the nomadic device 53 receives an automation service request message 216 from the VCS 1 via the local connection 202. The automation service request message 216 may be received by the nomadic device 53 responsive to user input to the VCS 1 requesting performance of a home automation action.

At block 1106, the nomadic device 53 provides an automation service request command 210 from the nomadic device 53 to the automation service 208 via the wide-area connection 206. For example, the automation control application 214 may be configured to receive the automation service request message 216 via the connected application interface 204 of the VCS 1. In turn, the automation control application 214 may send an automation service request command 210 to a corresponding automation service 208 to which the automation control application 214 is logged into. For example, temperature commands 210 may be provided to a climate automation service 208, door commands 210 may be provided to a security automation service 208, and light commands 210 may be provided to a light automation service 208.

At block 1108, the nomadic device 53 receives an automation service command response 212 from the automation service 208 via the wide-area data connection 206. For example, the automation service 208 may provide a response 212 via the wide-area data connection 206 to the nomadic device 53 indicative of whether the automation service request command 210 was successful. As another example, the nomadic device 53 may send a follow-up automation service request command 210 to the automation service 208 to determine whether the requested automation command 210 was performed. For instance, if the command 210 requested that a light be turned on, the follow-up command 210 may be configured to request the current state of the light, to ensure that it is now on.

At block 1110, the nomadic device 53 forwards the automation service response 212 from the nomadic device 53 to the VCS 1 via the local connection 202. For example, responsive to the automation service response 212 received over the wide-area connection 206, the automation control application 214 may provide a message response 218 to the VCS 1, via the local connection 202 and connected application interface 204, indicative of whether the chosen action was successfully performed by the automation service 208. After block 1110, the process 1100 ends.

Variations on the process 1100 are possible. As an example, the automation control application 214 may be configured to log into the automation services 208 in block 1106 when sending the commands 210, rather than in block 1102.

FIG. 12 illustrates an exemplary process 1200 for providing automation alerts 902 services. As with the process 1100, the process 1200 may be performed, for example, by the automation control application 214 executed by the nomadic device 53, where the nomadic device 53 is in communication with the VCS 1 over the local connection 202 and with the automation service 208 via the wide-area connection 206.

At block 1202, the nomadic device 53 identifies an automation status. As an example, the automation control application 214 may be configured to cause the nomadic device 53 to periodically send automation commands 210 to the automation service 208 requesting the current status of various automated items. For instance, the nomadic device 53 may periodically send automation commands 210 to the security automation service 208 requesting the current status of controlled doors, to determine whether any doors are unlocked or opened. Or, the nomadic device 53 may identify the automation status as a change in automation status, and may determine, for example, whether any controlled doors have been unlocked or opened since the last periodic request. As another example, the automation service 208 may be configured to automatically notify connected devices (such as the nomadic device 53) when the status of an automated item changes.

At block 1204, the nomadic device 53 identifies a current vehicles 31 location. For example, the automation control application 214 may be configured to utilize a GPS receiver of the nomadic device 53 or a GPS receiver of the vehicle 31 to determine a current location of the vehicle 31.

At decision block 1206, the nomadic device 53 determines whether the vehicle 31 is at home. For example, the automation control application 214 may be configured to compare the vehicle 31 location identified at block 1204 with a maintained location of the home. If the vehicle 31 is outside of a predetermined distance from the maintained home location (e.g., at least 1000 feet away), control passes to block 1208. Otherwise, the automation control application 214 determines that no alert is required and the process 1200 ends.

At block 1208, the nomadic device 53 provides an automation alert 902 via the vehicle HMI. For example, the automation control application 214 may generate the automation alert 902, including an indication 904 that the automation alert 902 is a home alert and an alert description 906 specifying the automation status or identified change in automation status. An exemplary automation alert 906 is illustrated above with respect to the user interface 900. After block 1208, the process 1200 ends.

Thus, the automation control application 214 may allow a user to connect to various home automation services 208 associated with the user's nomadic device 53, to allow the user to send automation commands 210 as well as to receive status information using the vehicle HMI.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a nomadic device configured to
connect to a vehicle computing system over a local connection and to an automation service over a wide-area connection,
receive a message from the vehicle computing system over the local connection requesting a home automation action to be performed, and
responsive to the message, send a command over the wide-area connection to an automation service to request the home automation action.

2. The system of claim 1, wherein the local connection includes at least one of a Bluetooth connection and a universal serial bus (USB) connection.

3. The system of claim 1, wherein the wide-area connection includes an Internet connection.

4. The system of claim 1, wherein the nomadic device is further configured to log into an account of the automation service associated with a home of a user of the vehicle according to credentials received from the user via a user interface of at least one of the nomadic device and the vehicle computing system.

5. The system of claim 1, wherein the automation service includes one of a thermostat automation service, a security automation service, and a lights automation service.

6. The system of claim 1, wherein the home automation action includes a request for automation information, and wherein the nomadic device is further configured to receive a command response over the wide-area connection responsive to the command and including the automation information.

7. The system of claim 1, wherein the message requesting the home automation action to be performed is received from the vehicle computing system responsive to user input to a user interface of the vehicle computing system.

8. The system of claim 7, wherein the user input includes at least one of voice command input requesting the home automation action to be performed and touchscreen input requesting the home automation action to be performed.

9. The system of claim 1, wherein the nomadic device is further configured to:
identify an automation status change in a home under automation control of the automation service,
identify a current vehicle location, and
when the vehicle is determined to be at least a predetermined distance from the home, send a message to the vehicle configured to cause the vehicle to display an automation alert in a user interface of the vehicle, the alert specifying the automation status change.

10. A system comprising:
a vehicle controller configured to
connect to a nomadic device over a local connection, the nomadic device configured to connect to an automation service over a wide-area connection,
receive input to a user interface of the vehicle computing system requesting performance of a home automation action of the automation service, and
responsive to the input, send a command over the local connection to request the home automation action.

11. The system of claim 10, wherein the local connection includes at least one of a Bluetooth connection and a universal serial bus (USB) connection, and the wide-area connection includes an Internet connection.

12. The system of claim 10, wherein the nomadic device is further configured to log into an account of the automation service associated with a home of a driver of the vehicle according to credentials received from the user via a user interface of at least one of the nomadic device and the vehicle computing system.

13. The system of claim 10, wherein the automation service includes one of a thermostat automation service, a security automation service, and a lights automation service.

14. The system of claim 10, wherein the home automation action includes a request for automation information, and wherein the nomadic device is further configured to receive a command response over the wide-area connection responsive to the command and including the automation information.

15. The system of claim 10, wherein the input includes at least one of voice command input requesting the home automation action to be performed and touchscreen input requesting the home automation action to be performed.

16. A system comprising:
a nomadic device configured to
identify an automation status in a home under automation control of an automation service,
identify a current vehicle location, and
when the vehicle is determined to be at least a predetermined distance from the home, send a message to the vehicle configured to cause the vehicle to display an automation alert in a user interface of the vehicle, the alert specifying the automation status.

17. The system of claim 16, wherein the current vehicle location is identified according to at least one of: a global positioning system of the nomadic device, and a global positioning system of the vehicle.

18. The system of claim 16, wherein the nomadic device is further configured to:
connect to a vehicle computing system over a local connection and to an automation service over a wide-area connection,
receive a message from the vehicle computing system over the local connection requesting a home automation action to be performed, and
responsive to the message, send a command over the wide-area connection to an automation service to request the home automation action.

19. The system of claim 16, wherein the automation status is a change in automation status.
